(19) United States
(12) Patent Application Publication
(10) Pub. No.: US 2008/0069681 A1
(43) Pub. Date: Mar. 20, 2008

(54) Lumber stacker apparatus

(75) Inventors: Paul Lamont Halper, Enderby (CA); Michael Derit Cesselli, Enderby (CA)

Correspondence Address: MAYBACK & HOFFMAN, P.A., 5722 S. FLAMINGO ROAD #232, FORT LAUDERDALE, FL, 33330, US

(73) Assignee: SEC Sawmill Equipment Company, Inc.

(21) Appl. No.: 11/521,024

(22) Filed: Sep. 14, 2006

(51) Int. Cl. B65G 57/22

(52) U.S. Cl. 414/791.6

(57) ABSTRACT

A lumber stacker apparatus for moving a course of lumber and depositing the course on a stack of lumber includes a crank mechanism, a fork assembly, an arm member, and motor means. The crank mechanism is operatively engaged to the fork assembly by the arm member. The arm member has a crank arm affixed to a crank shaft to move the fork assembly in a reciprocating stroke in response to rotation of the crank shaft. The motor means is operatively connected to the crank shaft to rotate the crank shaft at a constant angular velocity through 200° to 260°, preferably 230°, to drive the fork assembly through a slow forward stroke, to move the course of lumber, and to rotate the crank shaft through 100° to 160°, preferably 130°, to drive the fork assembly through a rapid backward stroke once the course of boards has been deposited on the stack of lumber.

### FIELD OF THE INVENTION

The invention relates to lumber stackers and more particularly to lumber stackers having improved mechanisms for handling successive courses or layers of lumber during the formation of upright stacks of lumber.

### DESCRIPTION OF THE PRIOR ART

The lumber industry throughout the world has become highly mechanized in recent years to a point that the most time consuming operation presently is the stacking of lumber after it has been sorted at the saw mill.

Lumber stacking refers to the laying of a pre-determined number of boards forming layers or courses of lumber. Typically, the stacking involves forming a bottom layer of boards upon a horizontal support and forming additional layers which are spaced apart by stacking sticks or checking sticks. Stacking sticks are placed across the top of each course of boards with pre-determined spaces between them.

Automated lumber stackers receive lumber from a saw mill via transfer chains. This lumber is then formed into successive layers or courses which are held in place on the lumber stacker by stops or hooked portions. A mechanized set of arms or forks rise under the course of boards to pick them up and move them out over a forming stack. A stop abuts the back edge of the layer of boards from returning to the course maker when the forks retract, thereby depositing the course of boards on the forming stack. In this type of operation, the stacking sticks may be placed loosely in U-shaped holders on each side of the stack. The course is placed onto the sticks and is not slid over the sticks.

Typically, reciprocating fork mechanisms as shown in U.S. Pat. No. 3,908,834 and U.S. Pat. No. 3,760,959 use a bell-crank drive and linkage to reciprocate the forks of the lumber stacker back and forth. Each of these systems relies on linkages to connect the drive to the linkage to move the forks. The resulting forces on the linkages and the geometry required to create the movement of the forks can cause erratic behaviour in the lumber stacker framework, particularly when operated at high speed. The geometry of previous lumber stackers is typically complex and the control of fork motion to effectively stack lumber is dependant on motor control. Sophisticated motion control or and electronic or hydraulic or pneumatic actuators have been incorporated into these drive systems to control the reciprocating motion of the forks. These systems are typically complex, difficult to troubleshoot and are expensive to maintain.

### SUMMARY OF THE INVENTION

The present invention provides a lumber stacker apparatus for moving a course of lumber and depositing the course on a stack of lumber, comprising a crank mechanism, operatively engaged to a fork assembly by an arm member, having a crank arm affixed to a crank shaft, to move the fork assembly in a reciprocating stroke in response to rotation of the crank shaft, and motor means operatively connected to the crank shaft to rotate the crank shaft at a constant angular velocity through 200° to 260°, preferably 230°, to drive the fork assembly through a slow forward stroke, to move the course of lumber, and to rotate the crank shaft through 100° to 160°, preferably 130°, to drive the fork assembly through a rapid backward stroke once the course of boards has been deposited on the stack of lumber.

Advantageously, the present invention permits a variable speed reciprocating stroke of the fork assembly in response to the rotation of the crank shaft at a constant angular velocity. This feature ameliorates the requirement for sophisticated motion controls systems that are present in previous lumber stacker systems.

The crank arm may have a slider block located at an end of the crank arm distal from the crank shaft. Preferably, the slider block may be received in a recess of complimentary configuration located on the arm member.

The arm member may be pivotally connected at one end to a frame of the lumber stacker apparatus to provide oscillatory movement in response to the rotation of the crank shaft. The arm member may be pivotally engaged to the fork assembly at the other end of the arm member.

Preferably the arm member is a yoked arm member; most preferably the arm member is a yoked-pitman arm.

The fork assembly may comprise an elongated fork portion connected to a carriage portion. Preferably, the carriage portion may be slidably engaged to a track located on the frame of the lumber stacker.

The elongated fork portion may comprise a raised portion having a step and an angled front portion. The elongated fork portion may further comprise an upstanding portion secured on the step. Preferably, the upstanding portion is a lug. The lug may have a roller located at its end.

The carriage portion may comprise rollers that engage opposing faces of the track. Preferably, the carriage portion comprises a substantially triangular section in which a roller is located at each point of the triangular section. The track may guide the carriage portion to move in a substantially horizontal path within the confines of the lumber stacker apparatus frame.

Preferably, the crank arm may rotate through 360° to complete a single stacking cycle. A single cycle of stacking comprises one course of lumber being added to a stack of lumber. Preferably, when the crank arm has rotated through about 200° to 260°, in particular 230°, the fork assembly is moved forward of the lumber stacking machine. When the crank arm is rotated through about 100° to 160°, in particular 130°, of rotation, the fork assembly is moved rearward of the machine.

A person of skill in the art will appreciate that these degrees of rotation may be altered by, for example, locating the crank shaft at a distance closer to, or further away from, the pivotal attachment of the arm member to the frame of the lumber stacker. Alternatively, the crank arm may be provided with means to extend or retract the crank arm, thus providing an adjustment in the degree rotation of the crank arm to complete a stacking cycle.

### BRIEF DESCRIPTION OF THE DRAWINGS

The present invention will now be described with reference to the following drawings of which,

FIG. 1 is a side elevation of the lumber stacker in accordance with the present invention;

FIG. 2 is a side elevation of the fork assembly in accordance with the present invention;

FIG. 3 is a side elevation of the lumber stacker in accordance with the present invention showing a forward stroke of the fork assembly;

FIG. 4 is a side elevation of the crank arm mechanism in a accordance with the present invention; and

FIG. 5 is a graphical illustration of a stroke of the fork assembly.

### DETAILED DESCRIPTION OF THE PREFERRED EMBODIMENTS

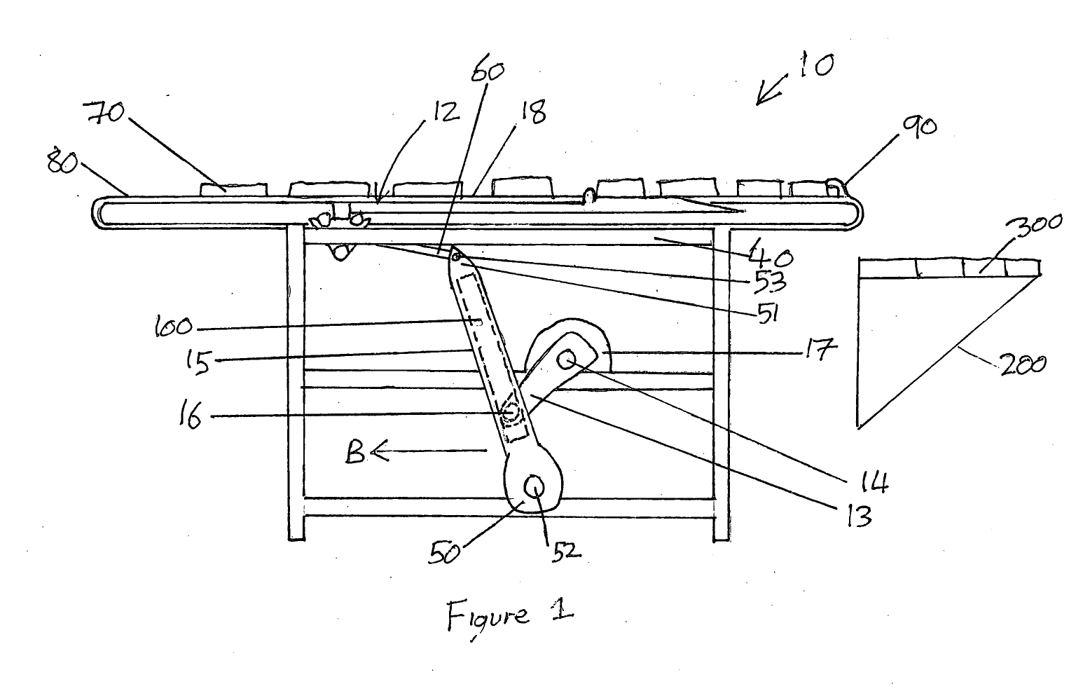

Referring to FIG. 1 a lumber stacking apparatus is shown at 10. The lumber stacking apparatus 10 comprises a crank mechanism 11, operatively engaged to a fork assembly 12, having a crank arm 13 affixed to a crank shaft 14. The crank arm 13 is in sliding engagement with a yoked-pitman arm 15. The crank arm 13 is provided with a slider block 16. The slider block 16 is received by a recess 100 of complimentary configuration located in the yoked-pitman arm 15. Motor means 17 are operatively connected to the crank shaft 14.

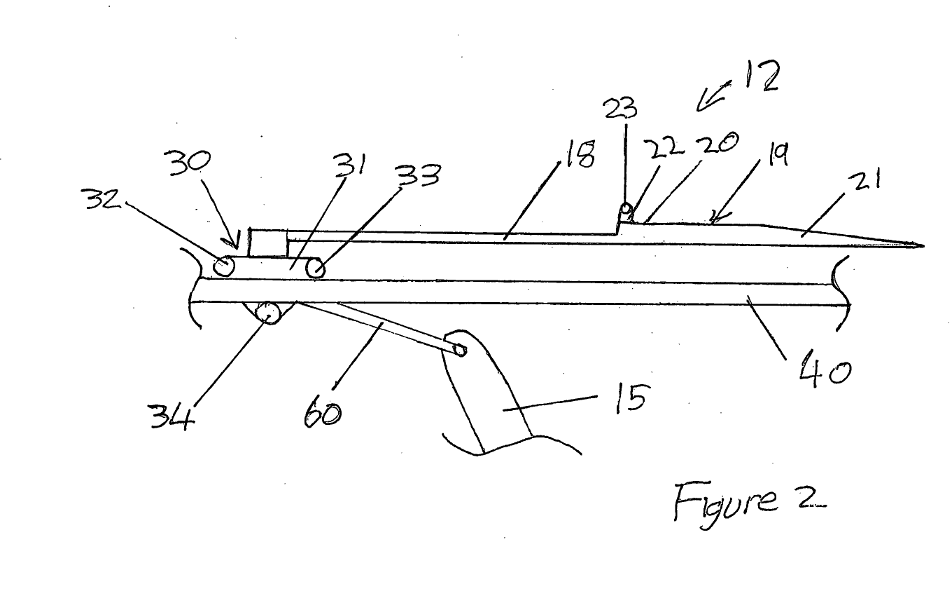

Referring to FIG. 2, the fork assembly 12 comprises an elongated fork portion 18. The elongated fork portion 18 comprises a raised portion 19 having a step 20 and an angled front portion 21. The elongated portion 18 has an upstanding lug 22 located on the step 20. The lug 22 has a small roller 23 located on its other end.

The elongated fork portion 18 is connected to a carriage portion 30. The carriage portion comprises a substantially triangular section 31 having rollers 32, 33, 34 located at each point of the substantially triangular section 31. The carriage 30 is in sliding engagement with a track 40 that extends along the frame of the lumber stacker 10. The rollers 32, 33, 34 engage opposing faces of the track 40. The track 40 guides the carriage portion 30 to move in a substantially horizontal path within the confines of the lumber stacker frame.

The yoked-pitman arm 15 is attached at one end 50 to the frame of the lumber stacker apparatus 10 by a pivot 52 and is attached to the fork assembly 12 at its other end 51 by a further pivot 53. The yoked-pitman arm 15 is operatively connected to the fork assembly by a link 60.

Referring to FIG. 1 the lumber stacker apparatus 10 begins a stacking cycle by receiving lumber 70 from transfer chains 80. The lumber is held on the lumber stacker apparatus 10 by a hooked portion 90; the transfer chains 80 slide underneath the lumber 70.

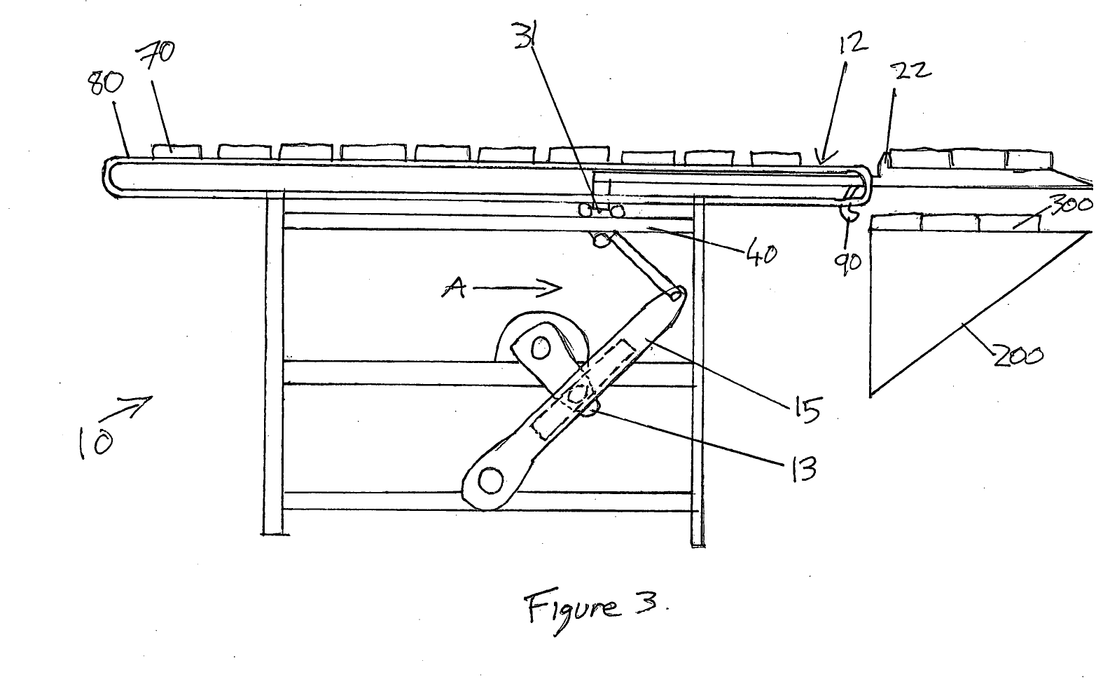

Referring to FIG. 3, the motor means 17 rotates the crank shaft 14 at a constant angular velocity which in turn rotates the crank arm 13 clockwise. The clockwise motion of the crank arm 13 moves the yoked-pitman arm 15 forward in the direction of arrow A, which in turn moves the fork assembly through a forward stroke. The fork assembly 12 is moved forward in a linear, substantially horizontal path, guided by the carriage portion 30 in sliding engagement with the track 40. The fork assembly 12 carries a course of lumber through the forward stroke. When the fork assembly 12 is moved through a forward stroke, the hooked portion 90 is retracted, and the fork assembly 12 carrying the course of lumber is moved forward at a speed faster than the transfer chains 80 carrying the lumber 70.

As the fork assembly 12 is moved forward, lumber 70 which is normally held together by rough edges is separated. Upon further forward movement of the fork assembly 12 the lug 22 abuts against the rearward edge of the last piece of lumber 70 in the course. The course of lumber is then deposited onto to a stack of lumber being formed 300 and the fork assembly 12 is then withdrawn. At this point in the stacking cycle, the crank arm has been rotated through 230°.

The lumber 70 is stacked upon a platform 200 such that when a course of lumber is placed upon it, it automatically drops approximately the height of the course so permitting the next course of lumber to be placed on it at the same height as was the previous course.

Referring to FIG. 1 the motor means 17 continues to rotate the crank arm 13 clockwise to withdraw the fork assembly 12 through a backward stroke, in the direction of arrow B, from the stack of lumber being formed 300. The crank arm 13 is rotated to 130° to withdraw the fork assembly 12. When the fork assembly 12 is withdrawn, retention members (not shown) are used to align the rearward edge of the stack being formed 300 to prevent the course of lumber from re-entering the lumber stacker apparatus 10.

As the fork assembly 12 is withdrawn the hooked portion 90 is extended to hold the next course of lumber being moved by the transfer chains 80. The fork assembly 12 is moved backwards in a linear, substantially horizontal path, guided by the carriage portion 30 in sliding engagement with the track 40.

The fork assembly 12 is withdrawn through the backward stroke and a higher speed than it is moved through the forward stroke when the fork assembly 12 is carrying lumber 70, whilst the crank arm is rotated at a constant angular velocity. The stacking cycle is then repeated.

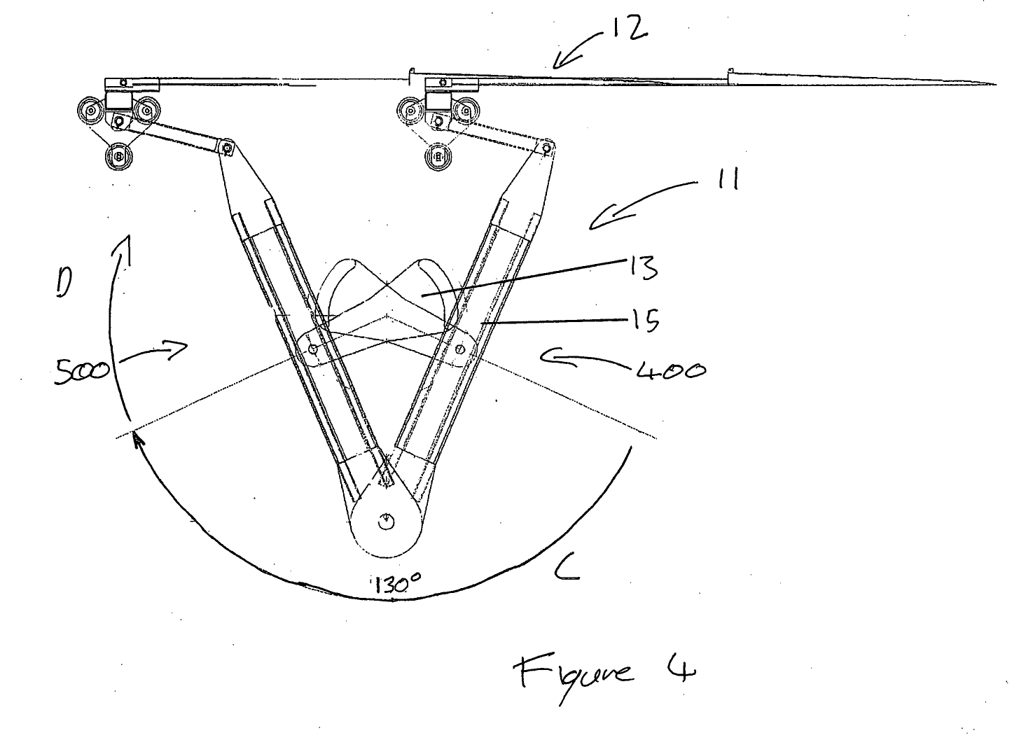

Referring to FIG. 4, a side elevation of the crank mechanism 11 is shown in operative engagement with a fork assembly 12. The crank arm 13 is in sliding engagement with a yoked-pitman arm 15. The fork assembly 12 is shown in a forward condition 400 and a subsequent rearward condition 500. When the fork assembly 12 is located in the forward condition 500, the crank arm 13 is rotated through 130°, in the direction of arrow C, to drive the fork assembly through a rapid backward stroke such that the fork assembly 12 is then located in a rearward condition 500. In order to move the fork assembly 12 to a forward condition 400, the crank arm 13 is rotated by 230°, in the direction of arrow D, to drive the fork assembly 12 through a slow forward stroke, such that the fork assembly 12 is then located in the forward condition 400. In this non-limiting example, a complete rotation of 360° represents one stacking cycle.

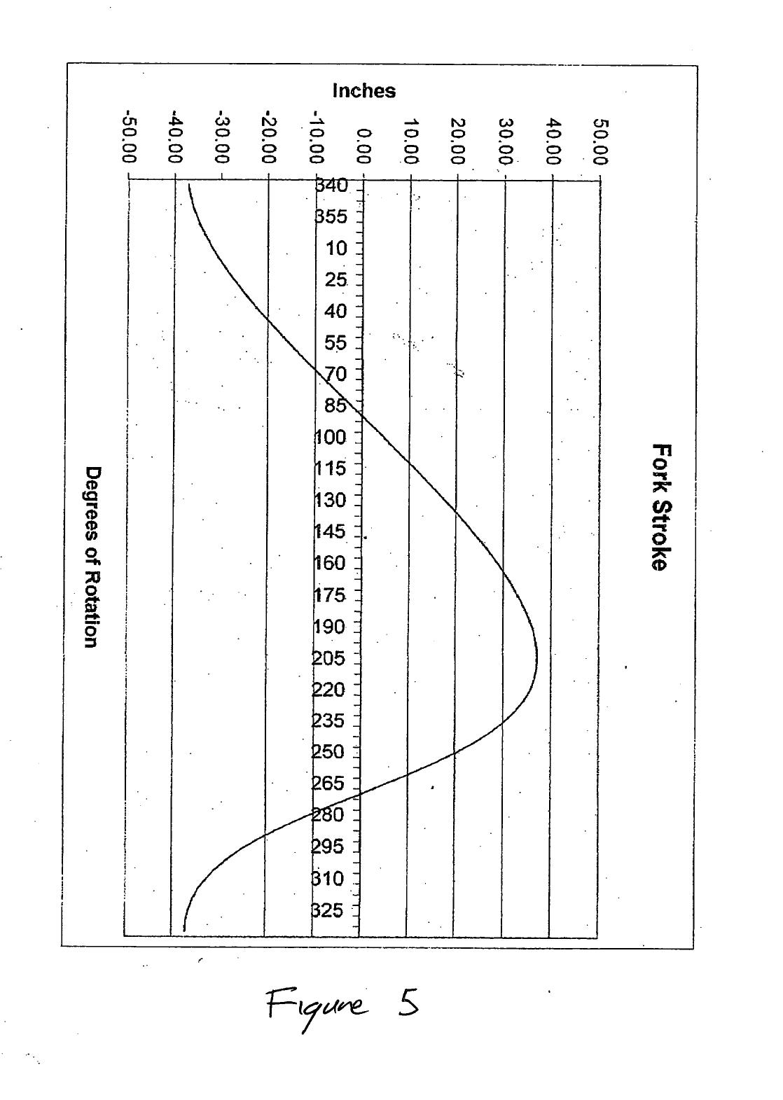

Referring to FIG. 5, the degrees of rotation of the crank shaft with respect to the forward and rearward motion of the fork assembly in inches, is depicted graphically.

The graph shows that when the crank shaft is rotated through 230°, the fork assembly is moved through a slow forward stroke. The fork assembly is then moved through a rapid backward stroke when the crank shaft is rotated a further 130°.

What is claimed is:

1. A lumber stacker apparatus for moving a course of lumber and depositing the course on a stack of lumber, comprising a crank mechanism, operatively engaged to a fork assembly by an arm member, having a crank arm affixed to a crank shaft, to move the fork assembly in a reciprocating stroke in response to rotation of the crank shaft, and motor means operatively connected to the crank shaft to rotate the crank shaft at a constant angular velocity through between 200° and 260° to drive the fork assembly through a slow forward stroke, to move the course of lumber, and to rotate the crank shaft through between 100° and 160° to drive the fork assembly through a rapid backward stroke once the course of boards has been deposited on the stack of lumber.

2. The lumber stacker apparatus according to claim 1, wherein the crank arm is provided with a slider block located at an end of the crank arm distal from the crank shaft.

3. The lumber stacker apparatus as claimed in claim 2, wherein the slider block is received by the arm member in a recess of complimentary configuration.

4. The lumber stacker apparatus according to claim 1, wherein the arm member is pivotally connected at one end to a frame of the lumber stacker apparatus to provide an oscillatory movement in response to the rotation of the crank shaft.

5. The lumber stacker apparatus according to claim 1, wherein the arm member is pivotally engaged to the fork assembly at another end of the arm member.

6. The lumber stacker apparatus according to claim 1, wherein the arm member is a yoked arm member.

7. The lumber stacker apparatus according to claim 6, wherein the yoked arm member is a yoked-pitman arm.

8. The lumber stacker apparatus according to claim 1, wherein the fork assembly comprises an elongated fork portion connected to a carriage portion.

9. The lumber stacker apparatus according to claim 8, wherein the carriage portion is slidably engaged to a track located on the frame of the lumber stacker apparatus.

10. The lumber stacker apparatus according to claim 8, wherein the elongated fork portion comprises a raised portion having a step and an angled front portion.

11. The lumber stacker apparatus according to claim 8, wherein the elongated fork portion further comprises an upstanding portion secured on the step.

12. The lumber stacker apparatus according to claim 11, wherein the upstanding portion is a lug.

13. The lumber stacker apparatus according to claim 12, wherein the lug has a roller located at its end.

14. The lumber stacker apparatus according to claim 8, wherein the carriage portion comprises two or more rollers that engage opposing faces of the track.

15. The lumber stacker apparatus according to claim 8, wherein the carriage portion comprises a substantially triangular section in which a roller is located at each point of the triangular section.

16. The lumber stacker apparatus according to claim 8, wherein the track guides the carriage portion to move in a substantially horizontal path within the confines of the lumber stacker apparatus frame.

17. The lumber stacker apparatus according to claim 1, wherein the crank arm rotates through 360° to complete a single stacking cycle.

18. The lumber stacker apparatus according to claim 1, wherein said crank shaft is rotated approximately 230° to drive the fork assembly through said forward stroke and is rotated approximately 130° to drive the fork assembly through said backward stroke.

19. A lumber stacker apparatus for moving a course of lumber and depositing the course on a stack of lumber, comprising a crank mechanism, operatively engaged to a fork assembly by an arm member, having a crank arm affixed to a crank shaft, to move the fork assembly in a reciprocating stroke in response to rotation of the crank shaft, and motor operatively connected to the crank shaft to rotate the crank shaft at a constant angular velocity through between 200° and 260° to drive the fork assembly through a slow forward stroke, to move the course of lumber, and to rotate the crank shaft through between 100° and 160° to drive the fork assembly through a rapid backward stroke once the course of boards has been deposited on the stack of lumber.

20. A lumber stacker apparatus for moving a course of lumber and depositing the course on a stack of lumber, comprising:
a fork assembly;
a crank mechanism having:
a crank shaft; and
a crank arm affixed to said crank shaft;
an arm member operatively engaging said crank mechanism to said fork assembly to move said fork assembly in a reciprocating stroke in response to rotation of said crank shaft;
a motor connected to said crank shaft to rotate said crank shaft at a constant angular velocity where:
a rotation of between approximately between 200° and 260° drives said fork assembly through a relatively slow forward stroke to move the course of lumber; and
an additional rotation of said crank shaft through approximately between 100° and 160° drives said fork assembly through a relatively rapid backward stroke once the course of lumber has been deposited on the stack of lumber.

21. The lumber stacker apparatus according to claim 20, wherein said crank shaft is rotated approximately 230° to drive the fork assembly through said forward stroke and is rotated approximately 130° additionally to drive the fork assembly through said backward stroke.
